(19) United States
(12) Patent Application Publication
(10) Pub. No.: US 2002/0104343 A1
(43) Pub. Date: Aug. 8, 2002

(54) Closure mechanism for a vehicle door

(76) Inventors: Dittmar Schwab, Rodgau (DE); Holger Schiffer, Meerbusch (DE)

Correspondence Address: Liniak, Berenato, Longacre & White, Suite 240, 6550 Rock Spring Drive, Bethesda, MD, 20817, US

(21) Appl. No.: 09/954,207

(22) Filed: Sep. 18, 2001

(30) Foreign Application Priority Data
Sep. 21, 2000 (DE) 10046717.2

(51) Int. Cl. E05B 65/12

(52) U.S. Cl. 70/237

(57) ABSTRACT

The invention relates to a closure mechanism (1) for a vehicle door, having disposed on the inner face of the vehicle door a mounting bracket (2) for the attachment of an external door handle (3) and of a locking cylinder (5) which is joined to an actuating lug (8) adapted to be swivelled against the pressure of a return spring (10).

In order to ensure that the locking cylinder (5) can be assembled to the vehicle door in a straightforward manner from the outside of the door after the mounting bracket (2) has been assembled, the invention proposes attaching the actuating lug (8), to which the lock linkage or a bowden cable can be secured, in a swivelling manner to the mounting bracket (2), and joining the locking cylinder (5) to the actuating lug (8) via a rotary coupling (7) in such a manner that upon insertion of the locking cylinder (5) into the mounting bracket (2) a first coupling element (14) of the locking cylinder (5), situated nearest to the actuating lug (8), engages in a corresponding second coupling element (16) of the actuating lug (8), with the result that the two coupling elements (14, 16) are joined to one another in a manner locked against rotation.

The invention relates to a closure mechanism for a vehicle door, having disposed on the inner face of the vehicle door a mounting bracket for the attachment of an external door handle and of a locking cylinder which is joined to an actuating lug adapted to be swivelled against the pressure of a return spring.

Closure mechanisms of this type, which are disposed in the region of the external door handle, have been known for a long time. The swivelling actuating lug which is attached to the locking cylinder is joined to one end of a linkage or bowden cable, the other end of which is operatively connected to the door lock. Particularly in the case of vehicle doors that have flap-type handles, the actuating lug and the locking cylinder constitute a unit which, after being suitably pre-assembled, is attached to the mounting bracket from the inner face of the door.

These closure mechanisms have the disadvantage that assembling the locking cylinder involves having to assemble it from the inner face of the vehicle door, since the actuating lug takes up a relatively large amount of space and this makes it impractical to assemble from the outer face of the door.

On the other hand, in the case of vehicle doors having bow-shaped or pull handles, a paddle-shaped actuating element is often attached to the locking cylinder. When assembling such locking cylinders. once the mounting bracket has been assembled the locking cylinder can be pushed from the outside into the mounting bracket and affixed thereto, the paddle-shaped actuating element being introduced directly into the door lock.

The drawback of this closure mechanism is the fact that it is necessary to locate the door lock in the immediate vicinity of the locking cylinder.

It is the object underlying the invention to indicate a closure mechanism of the type mentioned in the introduction, where once the mounting bracket has been assembled the locking cylinder can be assembled to the vehicle door from the outer face of the door without the need to site the door lock in the vicinity of the locking cylinder.

In accordance with the invention this object Is achieved by the features contained in claim 1. The subsidiary claims disclose additional, especially practical refinements of the invention.

The invention is essentially based on the idea of attaching the actuating lug, to which the lock linkage or a bowden cable can be secured, to the mounting bracket in a manner enabling said lug to swivel, and of joining the locking cylinder to the actuating lug via a rotary coupling, in such a manner that upon insertion of the locking cylinder into the mounting bracket, a first coupling element of the locking cylinder, situated nearest to the actuating lug, engages in a corresponding second coupling element of the actuating lug, with the result that the two coupling elements are joined together in a manner locked against rotation.

The attachment of the actuating lug to the mounting bracket can be done both before and after the latter is affixed in the vehicle door, and in the latter case the actuating lug is preferably clipped onto the mounting bracket from the inner face of the vehicle door.

One advantageous embodiment of the invention provides for the first coupling element to be equipped with vee-shaped projections and/or recesses on its side nearest to the actuating lug, and for the second coupling element to be equipped with vee-shaped recesses and/or projections on its side nearest to the locking cylinder, in such a manner that upon insertion of the locking cylinder from the outer face of the door the projections and/or recesses of the first coupling element engage in a form-fit in the recesses and/or projections of the second coupling element.

Further details and advantages of the Invention can be taken from the following exemplifying embodiments which are elucidated with the help of the drawing figures, wherein:

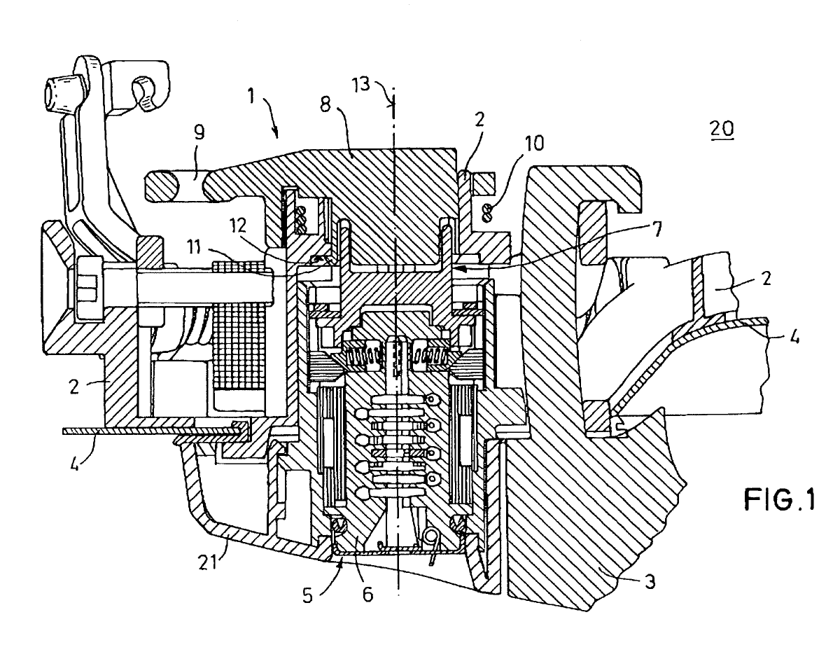

FIG. 1 shows a longitudinal section taken through a vehicle door in the region of the closure mechanism according to the invention, which is arranged on an external door handle, with the locking cylinder and the actuating lug joined via a rotary coupling;

FIG. 2 shows a perspective view of an actuating lug, seen from the locking cylinder;

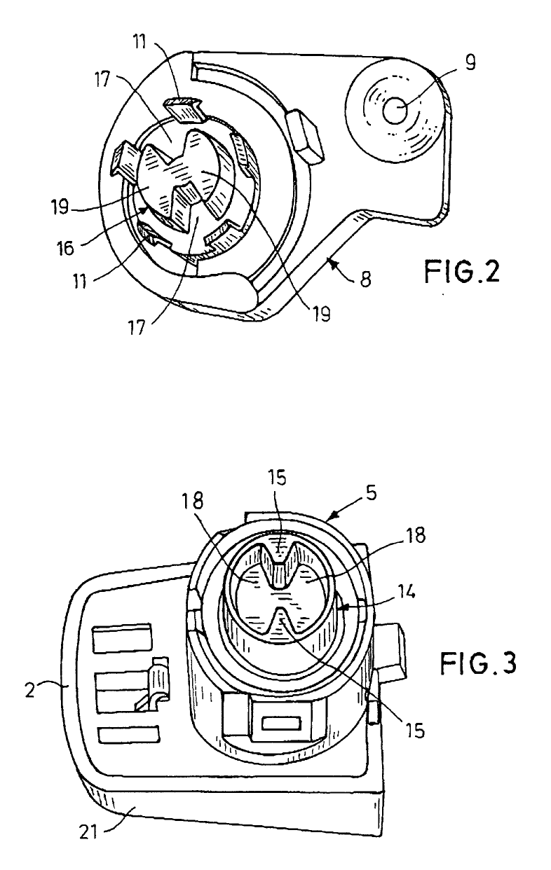

FIG. 3 shows a perspective view of the locking cylinder, seen from the actuating lug.

In FIG. 1 a closure mechanism for the side door of a motor vehicle is designated as 1. The closure mechanism 1 Is situated in the region of an external door handle 3 arranged on a mounting bracket 2, with the mounting bracket 2 being attached by its inner face to the outer skin 4 of the side door.

The closure mechanism 1 comprises a locking cylinder 5 with rotatable cylinder core 6 and an actuating lug 8 connected to the cylinder core via a rotary coupling 7. The actuating lug 8 incorporates an opening 9 into which a lock linkage (not shown) engages or a bowden cable joined to the door lock (likewise not shown) is attached.

The actuating lug 8 and a return spring 10 which keeps the actuating lug in its starting position are attached to the mounting bracket 2. To this end, on its side nearest to the locking cylinder 5 the actuating lug 8 has axially protruding peripheral zones in the form of clips 11 (FIG. 2), which engage behind a corresponding projection 12 on the mounting bracket (FIG. 1), thereby immobilising the actuating lug 8 axially and enabling it to swivel about the longitudinal axis 13 of the closure mechanism 1.

The rotary coupling 7 consists of a first coupling element 14 attached to the locking cylinder 5 and incorporating two opposing vee-shaped projections on its side nearest to the actuating lug 8 (FIG. 3), and a second coupling element 16 formed on the actuating lug 8 and incorporating opposing vee-shaped recesses 17 (FIG. 2). into which the projections 15 of the first coupling element 14 engage in a form-fit. In addition, the regions 18 between the projections 15 of the first coupling element 14 constitute recesses into which the regions 19 constructed as projections likewise engage in a form-fit between the recesses 17 of the second coupling element 16.

Assembling the closure mechanism I involves first of all clipping the actuating lug 8 along with the return spring 10 onto the mounting bracket 2. The mounting bracket 2 is then attached to the outer skin 4 of the vehicle door from the inner face of the door 20. Next the connection between the actuating lug 8 and the door lock can be made, e.g. by means of a linkage, and then the external door handle 3 and the locking cylinder 5 can be assembled and screwed on from the outside. Finally a cover panel 21 is clipped onto the locking cylinder 5 from the outside.

It will be readily understood that the invention is not confined to the exemplifying embodiment described above. It may, for instance, be useful to make the projections of one coupling element slimmer than the recesses of the second coupling element, so as not to directly cause the actuating lug to rotate when the cylinder core rotates. The coupling elements may also incorporate more than two projections or recesses, respectively. Moreover, the projections and recesses do not necessarily have to be vee-shaped, but can, for example, also be rectangular in shape.

List of reference numbers

| | |
|---|---|
| 1 | Closure mechanism |
| 2 | Mounting bracket |
| 3 | External door handle |
| 4 | Outer skin |
| 5 | Locking cylinder |
| 6 | Cylinder core |
| 7 | Rotary coupling |
| 8 | Actuating lug |
| 9 | Opening |
| 10 | Return spring |
| 11 | Clip |
| 12 | Projection (mounting bracket) |
| 13 | Longitudinal axis |
| 14 | First coupling element |
| 15 | (vee-shaped) projection |
| 16 | Second coupling element |
| 17 | (Vee-shaped) recess |
| 18 | Region (first coupling element), recess |
| 19 | Region (second coupling element), projection |
| 20 | Inner door face |
| 21 | Cover panel |

1. Closure mechanism for a vehicle door, having disposed on the inner face of the vehicle door a mounting bracket (2) for the attachment of an external door handle (3) and of a locking cylinder (5) which is joined to an actuating lug (8) adapted to be swivelled against the pressure of a return spring (10), said mechanism exhibiting the following features:
a) the swivelling actuating lug (8) and the return spring (10) are attached to the mounting bracket (2);
b) the locking cylinder (5) is arranged so as to be insertable into the mounting bracket (2) from the outer face of the door;
c) the locking cylinder (5) is joined to the actuating lug (8) via a rotary coupling (7), in such a manner that upon insertion of the locking cylinder (5) a first coupling element (14) thereof which is situated nearest to the actuating lug (8) engages in a corresponding second coupling element (16) of the actuating lug (8), with the result that the two coupling elements (14, 16) are joined together in a manner locked against rotation;

2. Closure mechanism according to claim 1, characterised in that the first coupling element (14) has projections (15) and/or recesses (18) on its side nearest the actuating lug (8), and the second coupling element (16) has recesses (17) and/or projections (19) on its side nearest the locking cylinder (5). in such a manner that upon insertion of the locking cylinder (5) the projections (15) and/or recesses (18) of the first coupling element (14) engage in the recesses (17) and/or projections (19) of the second coupling element (16).

3. Closure mechanism according to claim 2, characterised in that the projections (15, 19) and recesses (17, 18) are vee-shaped constructions.

4. Closure mechanism according to claim 2 or 3, characterised in that the first or second coupling element (14, 16) has at least two opposing projections (15, 19) and/or recesses (17, 18).

5. Locking cylinder according to claim 4, characterised in that the first and the second coupling element (14, 16) have both projections (15, 19) and recesses (17, 18), with the zones between the projections (15, 19) of one coupling element (14, 16) forming the recesses (17. 18) into which the projections (15,19) of the respective other coupling element (14, 16) engage.

6. Locking cylinder according to any of claims 2 to 5, characterised in that the projections (15) and/or recesses (18) of the first coupling element (14) engage in a form-fit in the recesses (17) and/or projections (19) of the second coupling element (16).

7. Locking cylinder according to any of claims 1 to 5, characterised in that on its side nearest to the locking cylinder (5) the actuating lug (8) has axially protruding peripheral zones in the form of clips (11), by means of which the actuating lug (8) can be attached to the mounting bracket (2).
